(19) United States
(12) Patent Application Publication
(10) Pub. No.: US 2014/0235779 A1
(43) Pub. Date: Aug. 21, 2014

(54) PROCESSING ZINC DIACRYLATE DISPERSED IN HIGH-CIS POLYBUTADIENE

(71) Applicant: Leo C. Goss, JR., Perry, OH (US)

(72) Inventor: Leo C. Goss, JR., Perry, OH (US)

(73) Assignee: RHEIN CHEMIE CORPORATION, Chardon, OH (US)

(21) Appl. No.: 14/234,271

(22) PCT Filed: Jul. 24, 2012
(86) PCT No.: PCT/US12/47909

§ 371 Date: Apr. 14, 2014

Related U.S. Application Data
(60) Provisional application No. 61/523,564, filed on Aug. 15, 2011.

(51) Int. Cl. C08K 5/098; C08K 5/01; C08K 3/22

(52) U.S. Cl. CPC C08K 5/098; C08K 3/22; C08K 5/01; C08K 2003/2296; C08K 2003/222; C08K 2003/2206
USPC 524/399

(57) ABSTRACT

The present invention provides a method and product that provides a dust-free homogeneous dispersion of zinc diacrylate in polybutadiene for use in golf balls in which a first and a second processing promoters are used in the production of the dispersion and incorporated into the dispersions, such first processing promoters including low molecular weight polyethylene, fatty acids, and zinc salts of fatty acids and such second processing promoters being metal oxides including zinc oxide, magnesium oxide, and calcium oxide.

This invention relates to a dispersion of zinc diacrylate in polybutadiene for use in golf balls and the production thereof, wherein a first and a second processing promoter is employed in the production of the dispersion and being incorporated therein.

U.S. Pat. No. 7,135,514 provides for a dispersion of zinc diacrylate in polybutadiene commonly used by golf ball manufacturers, in which processing promoters are included to achieve the dispersion. The '514 processing promoters are selected from the group of low molecular weight polyethylene, fatty acids, zinc salts of fatty acids and mixtures thereof.

It has now be found that further improvements to the zinc diacrylate in polybutadiene dispersions commonly used by golf ball manufacturers can be achieved via the addition of a second processing promoter to those first promoters as described in the '514 patent, in which this second processing promoter is a metal oxide.

In general, metal oxides have been employed heretofore as activators in curing systems or fillers. Surprisingly, however, it has now been found that the use of a metal oxide as a second processing promoter in the production of zinc diacrylate in polybutadiene dispersions results in improvements to both the extrusion flow properties (throughput rate) of the product and in the quality of pellitization, for example, in an improved pellet-size uniformity for the manufactured dispersion.

If not otherwise stated herein, it is to be assumed that all patents, patent applications, patent publications and other publications mentioned and cited herein are hereby fully incorporated by reference herein as if set forth in their entirety herein.

There is broadly contemplated, in accordance with at least one embodiment of the present invention, a rubber dispersion composition which comprises a mixture of i) from about 12 to 50 parts by weight of a polybutadiene; ii) from about 50 to 85 parts by weight of zinc diacrylate; iii) from about 0.5 to 5 parts by weight of a first processing promoter selected from the group of low molecular weight polyethylene, fatty acids, zinc salts of fatty acids and mixtures thereof; and iv) from about 0.5 to 5 parts by weight of a secondary processing promoter, wherein said secondary processing promoter is a metal oxide, and wherein said parts by weight are all based on the total weight of the dispersion. It being understood, the aforementioned parts by weight of each component being selected so as to result in a sum total of 100 parts by weight.

In another embodiment of the present invention there is a process for the production of a rubber dispersion composition comprising the steps of a) mixing i) from about 12 to 50 parts by weight of a polybutadiene; ii) from about 50 to 85 parts by weight of zinc diacrylate; iii) from about 0.5 to 5 parts by weight of a first processing promoter selected from the group of low molecular weight polyethylene, fatty acids, zinc salts of fatty acids and mixtures thereof; and iv) from about 0.5 to 5 parts by weight of a second processing promoter, thereby forming a mixture; b) extruding the mixture, thereby forming an extruded mixture; and pelletizing or slabbing said extruded mixture, and wherein said parts by weight are all based on the total weight of the dispersion. It being understood, the aforementioned parts by weight of each component being selected so as to result in a sum total of 100 parts by weight.

In another embodiment of the present invention, the metal oxide of the dispersion and process above is a zinc oxide, magnesium oxide, calcium oxide or a mixture thereof. In another embodiment of the present invention the metal oxide is zinc oxide.

For a better understanding of the present invention, together with other and further features and advantages thereof, reference is made to the following description.

The present invention provides for a dispersion of zinc diacrylate in polybutadiene and the process by which it is made. In one embodiment, the polybutadiene is a special high-cis grade of polybutadiene commonly used by golf ball manufacturers. The preferred high-cis polybutadiene is neodymium catalyzed and has a cis-1,4 content of above about 90% and more preferably above about 96%. However, any grade of polybutadiene can be used by compensating for the molecular weight differences, using more or less processing promoters. In one example grades of polybutadiene accepted by the various golf ball manufacturers are Buna GB 1220, 1221 and Taktene 221 from LANXESS Corporation.

If desired, the polybutadiene can also be mixed with other elastomers known in the art, such as natural rubber, styrene butadiene, and/or isoprene in order to further modify the properties of the core. When a mixture of elastomers is used, the amounts of other constituents in the core composition are generally based on 100 parts by weight of the total elastomer mixture.

Zinc diacrylate is a co-agent preferred for use in golf balls because it provides golf balls with a high initial velocity in the USGA test. The zinc diacrylate of the present invention can be of various grades of purity. Typical grades contain about 90% ZDA and 10% zinc stearate, which is either incorporated in-situ or post added. Suitable, commercially available zinc diacrylates can be obtained from Sartomer Company.

The preferred concentrations of the commercially available zinc diacrylate grades that can be used in this invention are from about 86 to 92 percent by weight zinc diacrylate and 8 to 14 percent zinc salts of fatty acids, preferably zinc stearate.

The combination of adding both a first and a second processing promoter of the present invention enable improved extrusion and pelletizing rates of the dispersion formed, as well as functioning as a separant to greatly minimize, if not totally eliminate, massing of the pelletized product. The resulting dust-free pelletized product, which can optionally be supplied in slab form, is capable of use for direct addition to golf-ball formulations for golf-ball manufacturing.

Preferred first processing promoters of an embodiment of the present invention are low molecular weight polyethylenes (MW approximately 800-2500); and fatty acids (preferably saturated fatty acids), zinc salts of fatty acids and combinations thereof. Oleic acid and zinc salts of oleic acid may also be used in the manufacture of the ZDA dispersion.

The preferred concentrations of first processing promoters that can be used are from 0.5 to 5 parts by weight based on the total weight of the said dispersion.

Preferred secondary processing promoters of an embodiment of the present invention are metal oxides such as zinc oxide, magnesium oxide, calcium oxide and mixtures thereof.

The preferred concentrations of secondary processing promoters that can be used are from 0.5 to 5 parts by weight based on the total weight of the said dispersion.

In one embodiment, the ZDA dispersion of the present invention is made in an internal mixer into which is first added the total amount of polymer, e.g., polybutadiene rubber, optionally some dispersion from a previous batch, all of the first and secondary processing promoters, and all of the ZDA powder. The mixed batch is discharged preferably at a mixer temperature of 200° F. (93° C.). The temperature of the batch obtained using a thermocouple is generally about 20° F. higher. The mix temperature is a compromise between being high enough to melt the first processing promoters and optionally to melt and disperse low-melt bags if desired, and low enough to minimize odor, undesired reactions and even decompositions.

Since ZDA poses a dust explosion hazard, all appropriate precautions are taken in the mixing area to minimize such hazard risks. Following the mixing operation, the homogeneous mixture is then pelletized using, for example, a dry-face-cutter-head on an extruder. Although pellets are the preferred form for automatic weighing, a slabbed version is also available by using a slot-die on the extruder. The mixing and forming processes used to make this product is known to the skilled artisan, but the process of mixing all the ingredients at once and the inclusion of previously mixed material is a material improvement to the process that shortens the total mixing time of the product.

Although the preferred embodiment of the present invention has been described herein, it is to be understood that the invention is not limited to that precise embodiment, and that various other changes and modifications may be affected therein by one skilled in the art without departing from the scope or spirit of the invention.

What is claimed is:

1. A rubber dispersion composition comprising:
from about 12 to 50 parts by weight of a polybutadiene;
from about 50 to 85 parts by weight of zinc diacrylate;
from about 0.5 to 5 parts by weight of a first processing promoter selected from the group consisting of low molecular weight polyethylene, fatty acids, zinc salts of fatty acids and mixtures thereof; and
from about 0.5 to 5 parts by weight of a second processing promoter which is a metal oxide,
all parts by weight being based on the total weight of said dispersion.

2. The composition according to claim 1, wherein said metal oxide is selected from the group consisting of zinc oxide, magnesium oxide, calcium oxide and mixtures thereof

3. The composition according to claim 1, wherein said metal oxide is zinc oxide.

4. The composition according to claim 1, wherein said polybutadiene is a high-cis-polybutadiene.

5. The composition according to claim 1, wherein said dispersion comprises from 12 to 22 parts by weight of said polybutadiene.

6. The composition according to claim 1, wherein said dispersion comprises 15 to 19 parts by weight of said polybutadiene.

7. The composition according to claim 1, wherein said dispersion comprises 70 to 85 parts by weight of zinc diacrylate based on the total weight of said dispersion.

8. The composition according to claim 1, wherein said dispersion comprises 75 to 85 parts by weight of zinc diacrylate based on the total weight of said dispersion.

9. The composition according to claim 1, wherein said first processing promoter is a low molecular weight polyethylene having a molecular weight from 750 to 2500.

10. The composition according to claim 1, wherein said first processing promoter is a blend of polymer olefin and polyethylene wax having a softening point around 112° C. and is present at 0.5 to 5.0 percent by weight of the total product.

11. The composition according to claim 9, wherein said first processing promoter is present at 2.5 to 3.5 percent by weight of the total product.

12. The composition according to claim 1, wherein said first processing promoter is a low molecular weight polyethylene with a softening point around 85° C.

13. The composition according to claim 1, wherein said first processing promoter is a low molecular weight polyethylene having a density of 1.33 g/cc and an ML(1+4)100° C. of 37.

14. The composition according to claim 1, wherein said first processing promoter comprises zinc salts of mainly unsaturated fatty acids.

15. The composition according to claim 1, wherein said first processing promoter is a blend of zinc salts of mainly saturated fatty acids having a density of 1.08 g/cc and a softening point about 100° C.

16. The composition according to claim 1, wherein said fatty acid is oleic acid.

17. The composition according to claim 1, wherein said zinc salts of fatty acids is a zinc salt of oleic acid.

18. A process for making a rubber dispersion comprising the steps of:
mixing
i) from about 12 to 50 parts by weight of a polybutadiene;
ii) from about 50 to 85 parts by weight of zinc diacrylate;
iii) from about 0.5 to 5 parts by weight of a first processing promoter selected from the group consisting of low molecular weight polyethylene, fatty acids, zinc salts of fatty acids and mixtures thereof; and
iv) from about 0.5 to 5 parts by weight of a second processing promoter which is a metal oxide; thereby forming a mixture,
where all parts by weight being based on the total weight of said dispersion; and
extruding said mixture thereby forming an extruded mixture; and
pelletizing or slabbing said extruded mixture.

19. The process according to claim 18, wherein said metal oxide is selected from the group consisting of zinc oxide, magnesium oxide , calcium oxide and mixtures thereof

20. The process according to claim 18, wherein said metal oxide is zinc oxide.

21. The process according to claim 18, wherein said polybutadiene is a high-cis-polybutadiene.

22. The process according to claim 18, wherein said dispersion comprises from 12 to 22 parts by weight of said polybutadiene.

23. The process according to claim 18, wherein said dispersion comprises 15 to 19 parts by weight of said polybutadiene.

24. The process according to claim 18, wherein said dispersion comprises 70 to 85 parts by weight of zinc diacrylate based on the total weight of said dispersion.

25. The process according to claim 18, wherein said dispersion comprises 75 to 85 parts by weight of zinc diacrylate based on the total weight of said dispersion.

26. The process according to claim 16, wherein said first processing promoter is a low molecular weight having a molecular weight from 750 to 2500 polyethylene.
